(19) United States
(12) Patent Application Publication
(10) Pub. No.: US 2011/0188253 A1
(43) Pub. Date: Aug. 4, 2011

(54) Optically Open Stacked Type Subminiature Optical Device

(75) Inventors: Hyun Su Kim, Gyeonggi-do (KR); Hyung Ju Kim, Gyeonggi-do (KR); Ho June Seo, Seoul (KR); Tae Ho Kil, Gyeonggi-do (KR)

(73) Assignee: Partron Co., Ltd., Hwaseong-si, Gyeonggi-do (KR)

(21) Appl. No.: 13/059,322

(22) PCT Filed: Dec. 31, 2009
(86) PCT No.: PCT/KR2009/008023

§ 371 Date: Apr. 12, 2011

(30) Foreign Application Priority Data
Jan. 6, 2009 (KR) 10-2009-0000676

(51) Int. Cl. F21V 7/00

(52) U.S. Cl. 362/296.01

(57) ABSTRACT

An optically open stacked type subminiature optical device according to the present invention has an independent aperture stop structure to enable designing of a stable small optical device having an optical open cover structure, thus improving optical performance. Further, the optically open stacked type subminiature optical device of the present invention is configured in that the aperture stop structure is assembled with another structure into a stacked structure to establish a stable assembly together with the cover structure, thereby allowing for ease of assembly and improving productivity.

### TECHNICAL FIELD

The present invention relates generally to an optical device installed in a mobile device, such as a mobile communication terminal, and used as a subminiature pointing device or an input device and, more particularly, to a subminiature optical device which is suitable for being used in an optically open touch type optical mouse.

### BACKGROUND ART

FIG. 1 shows an optical device including a lens/lens pipe structure 50, which is used for throwing light radiated from a light source 10 on an objective plane 30 that forms a lower surface of the optical device; and a chip package housing 60, which functions as an outermost cover of an optical device module and collaterally functions as a sensor protective structure and as a light receiving aperture placed beyond a reflected light receiving lens. The above-mentioned structure of the optical device was designed to be used in a mouse for a typical personal computer. In the optical device having the above-mentioned structure, the body of the optical device can intercept light diffused from the outside, so that the function of intercepting the diffused light has not been deemed an important factor in the optical device. However, when the objective plane is located in an upper surface instead of a lower surface of the optical device, whether the diffused light from the outside of the optical device can be intercepted or not is considered to be a very important factor, as shown in FIG. 8.

An optical device shown in FIG. 2 (disclosed in Korean Patent No. 10-0700507) includes: a lens structure 120 defining an optical path for light radiated from a light source 100; an objective plane 140 on which a material to be sensed is placed; a lens protective structure 130 for protecting the lens structure 120 and intercepting light diffused from the outside; a sensor 150 for sensing light reflected by the material placed on the objective plane 140; a sensor cover structure 110 for protecting the sensor 150 and controlling the quantity of light received by the sensor 150; and a PCB 160 on which the light source 100, the sensor 150 and the sensor cover structure 110 are mounted.

Here, the lens structure 120 includes an illumination optical unit for condensing and transmitting the light radiated from the light source 100 and a light receiving unit for throwing the light, which has been reflected by the material placed on the objective plane 140, onto the sensor 150.

In the optical devices, such as the optical device disclosed in the Korean patent, the light radiated from the light source 100, such as an LED, is condensed by the illumination optical unit and is thrown onto the objective plane 140. When the light has reached the objective plane 140, the image of the material placed on the objective plane 140 is transmitted to the sensor 150 by way of an imaging lens 121 of the light receiving unit, so that the sensor can produce a signal.

FIGS. 3 and 4 are exploded perspective views of conventional optical devices (subminiature optical mice) which are the same kind of the optical device disclosed in the above-mentioned Korean patent. As shown in the drawings, in each of the optical devices, a tape 350′ or 350″ is attached to a window made of a transparent acrylic material inside a cover structure 340′ or 340″, thus intercepting diffused light from the outside. In FIG. 3, the reference numeral 380′ denotes a body of the optical device having a PCB.

In the above-mentioned optically open type optical devices, the structure for intercepting the diffused light using the tape 350′, 350″ is advantageous in that it can avoid interference with another interior structure and can realize a thin structure. However, the above-mentioned optically open type optical devices are problematic in that it is difficult to form an optical structure, such as an aperture stop, on the tape and it is difficult to assemble the elements in precise locations required by a precise optical device. Therefore, in the related art, it has been required to provide an aperture stop structure, which can realize a design of a stable subminiature optical device having an improved optical performance.

### DISCLOSURE

### Technical Problem

The present invention is intended to design an optical device, which can realize smallness of a conventional optical pointing device and can realize a reliable optical opening and closing function, and is intended to provide an optically open stacked type subminiature optical device, in which a structure including an aperture stop structure is installed so that interior structures can have desired optical intercepting functions and respective desired optical transmitting functions, thereby designing the outermost cover structure in the form of an optically open stacked structure and realizing a stable subminiature optical device, and improving the optical performance of the optical device.

Further, the present invention serves to provide an optically open stacked type subminiature optical device, in which the aperture stop structure is assembled with another structure into a stacked structure, thus forming a stable assembly structure and realizing ease of assembly and improving productivity.

### Technical Solution

In an aspect, the present invention provides an optically open stacked type subminiature optical device, including: a light source and a light receiving sensor separately installed on a PCB; a darkroom structure installed on the PCB so as to cover the light receiving sensor and, at the same time, configured to pass therethrough light going to the light receiving sensor; a composite lens and prism structure stacked on the upper end of the darkroom structure and condensing the light radiated from the light source to an objective plane, and condensing the light reflected by the objective plane onto the light receiving sensor; a cover structure made of a semitransparent material and forming the objective plane in an upper part of the optical device, the cover structure being mounted on the PCB in such a way that the cover structure can cover the composite lens and prism structure and the darkroom structure; and an aperture structure configured as a plate structure and stacked on the upper end of the composite lens and prism structure inside the cover structure, the aperture structure having open holes, which can intercept diffused light from the objective plane of the cover structure, yet allowing both the light passing through the composite lens and prism structure and the light reflected by the objective plane to pass therethrough.

Here, the aperture structure may include: a first hole having an open structure for allowing the light passing through the composite lens and prism structure to be transmitted to the objective plane of the cover structure; and a second hole located at a location spaced apart from the first hole and allowing the light reflected by the objective plane of the cover structure to pass therethrough.

Here, the first hole may be rectangular, while the second hole may be circular.

Further, the composite lens and prism structure and the aperture structure may be configured to be combined with each other. In other words, a locking boss may protrude from the composite lens and prism structure, while the aperture structure may be provided with a locking hole, into which the locking boss is inserted so that the composite lens and prism structure and the aperture structure can be combined with each other. Of course, another combination structure, which is the reverse of the above-mentioned structure, may be realized.

The composite lens and prism structure may include a condensing prism for condensing light radiated from the light source onto the objective plane, in which, when an inclined reflexive surface is formed in the condensing prism, the aperture structure may be provided with an inclined protrusion at a portion on which the aperture structure comes into contact with the inclined reflexive surface, the inclined protrusion being formed by inclinedly protruding from the aperture structure.

Further, the aperture structure may be made of at least one of silicone, epoxy and synthetic resin materials or a mixture of at least two of them.

Further, the darkroom structure, the composite lens and prism structure and the aperture structure may be sequentially stacked and assembled in the cover structure in such a way that the darkroom structure is assembled with the composite lens and prism structure, and the composite lens and prism structure is assembled with the aperture structure.

### ADVANTAGEOUS EFFECTS

As described above, the optically open stacked type subminiature optical device according to the present invention has an independent aperture stop structure so that a stable subminiature optical device can be designed that has an optical open cover structure, thus having improved optical performance.

Further, the optically open stacked type subminiature optical device of the present invention is configured in that the aperture stop structure is assembled with another structure into a stacked structure to establish a stable assembly together with the cover structure, thereby allowing for ease of assembly and improving productivity.

### DESCRIPTION OF DRAWINGS

FIG. 1 is a sectional view showing the construction of an optical mouse for a personal computer according to prior art;

FIG. 2 is a view showing the internal construction of an integrated subminiature optical device according to one of the prior patents;

FIGS. 3 and 4 are exploded perspective views showing conventional light intercepting structures capable of intercepting ambient light rays using light intercepting tapes;

FIG. 5 is a sectional view showing an optically open subminiature optical device according to an embodiment of the present invention;

FIG. 6 is an exploded perspective view of the optically open subminiature optical device according to the embodiment of the present invention;

FIG. 7 is a perspective projection view showing the installation of an aperture stop structure in the assembled optical device according to the embodiment of the present invention; and

FIG. 8 is a view of an optical device having no aperture stop structure, showing ambient light rays entering the optical device.

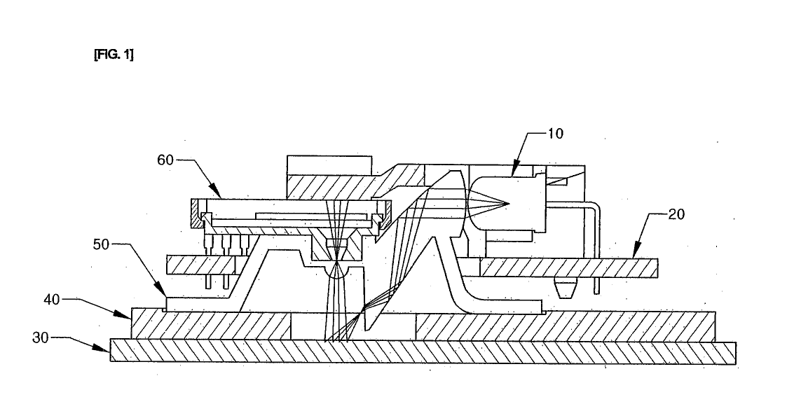

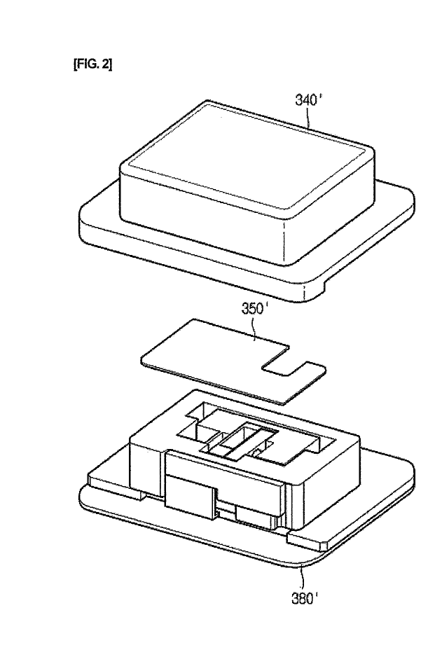

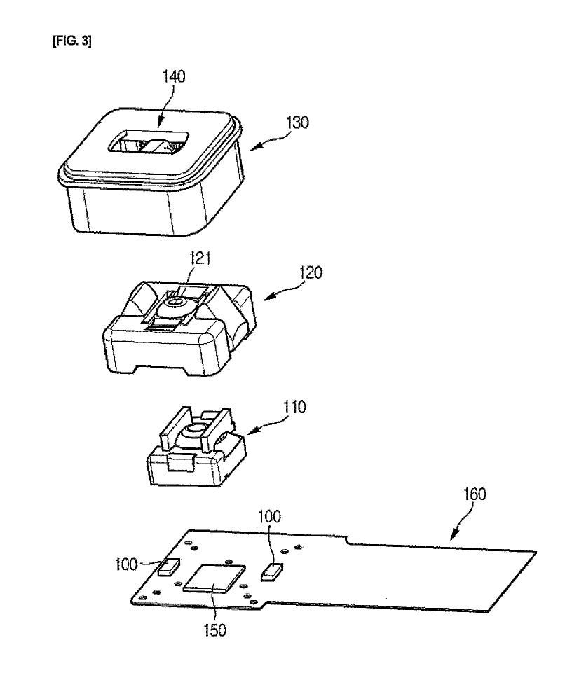

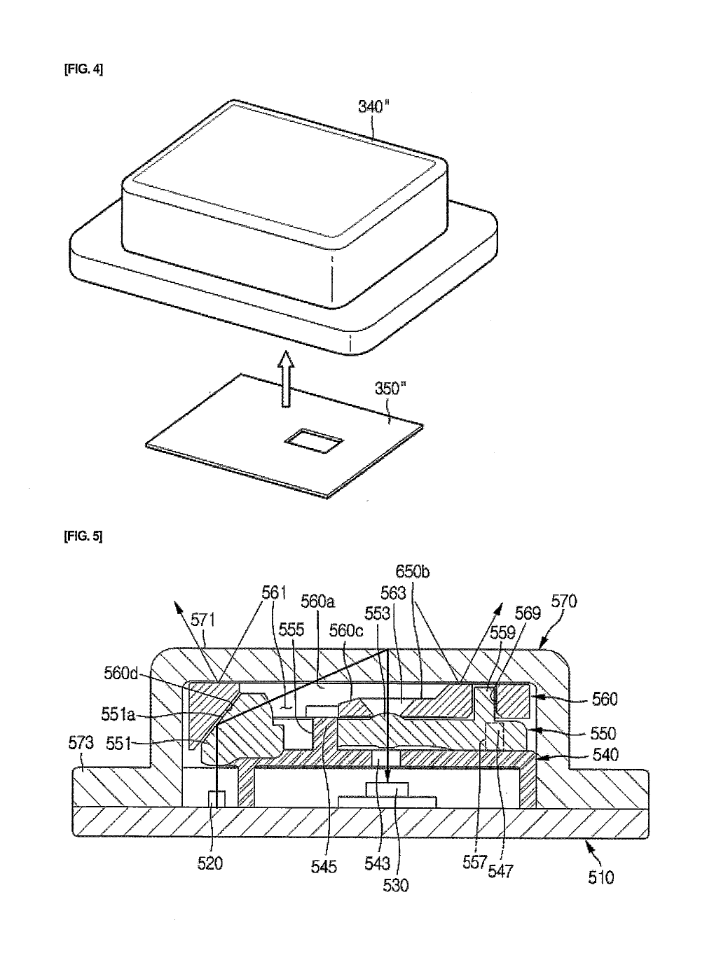

### BEST MODE

Hereinbelow, a preferred embodiment of the present invention will be described in detail with reference to the accompanying drawings.

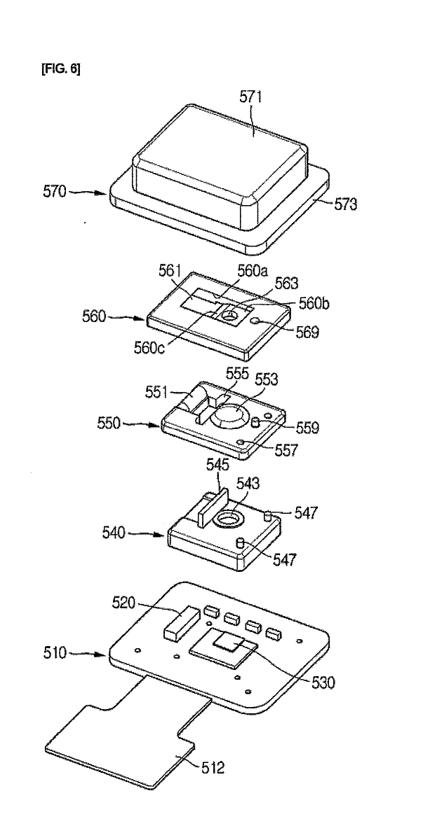

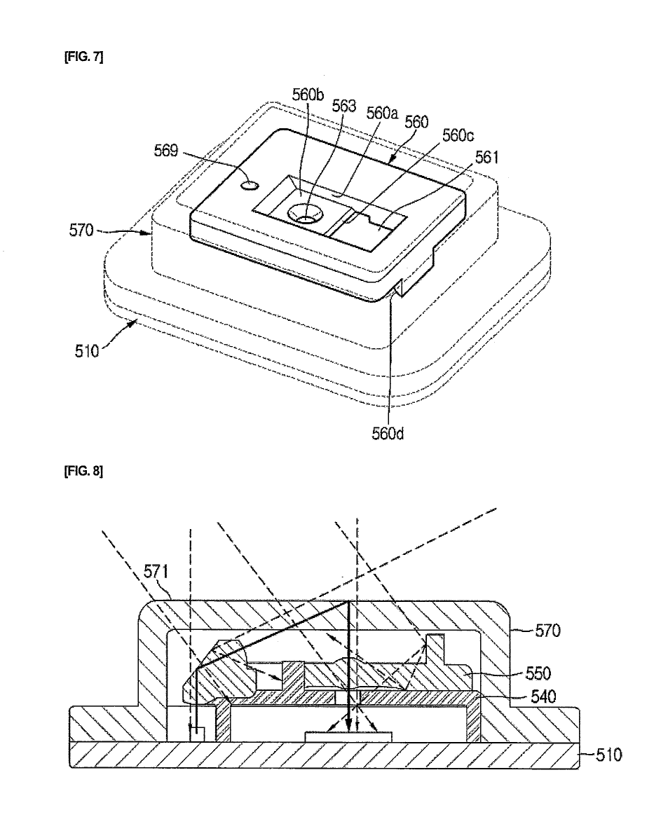

FIGS. 5 through 7 are views illustrating an optically open stacked type subminiature optical device according to an embodiment of the present invention, in which FIG. 5 is a sectional view, FIG. 6 is an exploded perspective view, and FIG. 7 is a perspective projection view showing the installation of an aperture stop structure in the assembled optical device.

As shown in the drawings, the optically open stacked type subminiature optical device according to the embodiment of the present invention includes: a light source 520 and a light receiving sensor 530 which are separately installed on a PCB 510; a darkroom structure 540 which is installed on PCB 510 in such a way that the darkroom structure can cover the light receiving sensor 530; a composite lens and prism structure 550 which is stacked on the upper end of the darkroom structure 540 and condenses light radiated from the light source 520 onto an objective plane 571, and condenses the light reflected by the objective plane 571 onto the light receiving sensor 530; a cover structure 570 which is made of a semitransparent material and forms the objective plane 571 and is mounted on the PCB 510 in such a way that the cover structure can cover both the composite lens and prism structure 550 and the darkroom structure 540; and an aperture structure 560 which is stacked on the upper end of the composite lens and prism structure 550 inside the cover structure 570 and intercepts light diffused from the objective plane 571.

Particularly, the aperture structure 560 includes open holes 561 and 563, through which both the light passing through the composite lens and prism structure 550 and the light reflected by the. objective plane 571 can pass.

The above-mentioned important parts of the present invention will be sequentially described in detail hereinbelow.

First, the PCB 510 is a base part, on which the parts constituting the optical device of the present invention are assembled into an integrated structure. The PCB 510 is electrically connected to the light source 520 and to the light receiving sensor 530, with a variety of required electronic devices being installed on the PCB. In FIG. 6, the reference numeral 512 denotes an FPCB which is electrically connected to an external circuit.

The light source 520 is an LED light source 520, which has a chip shape and is installed on the PCB 510. The light source 520 may use a variety of LEDs having different colors as desired without being limited to specific colors. Further, the light source 520 may use a variety of light emitting devices, such as laser diodes (LD) and lamp-type devices, in addition to LEDs.

The light receiving sensor 530 is a light receiving sensor which can receive the light sequentially passing through the aperture structure 560, the composite lens and prism structure 550 and the darkroom structure 540 after being reflected by the objective plane 571. The light receiving sensor 530 may be mounted on the PCB 510 by a wire bonding process or a flip chip bonding process.

The darkroom structure 540 is configured to execute both a sensor protecting function and an aperture function. In order to realize the above-mentioned object, the darkroom structure has a cap structure capable of sealing and protecting the light receiving sensor 530, with a light receiving hole 543 being formed in the darkroom structure so as to pass the light thrown on the light receiving sensor 530 therethrough. Here, the darkroom structure 540 may be configured such that the light source 520 can be installed in a space inside the darkroom structure or on a side of the darkroom structure. However, it should be understood that, even in this case, it is required to optically separate the light receiving sensor 530 from the light source 520.

In order to optically or electrically separate the light source 520 from the light receiving sensor 530, it is preferred that the darkroom structure 540 be made of an opaque synthetic resin material.

Further, the darkroom structure 540 isolates the light receiving sensor 530 from the light source 520 and is provided with a light intercepting rib 545 for intercepting the light, which has been radiated from the light source 520 and has been diffused to be thrown on the light receiving sensor 530. Here, it is preferred that the light intercepting rib 545 be configured to protrude upwards at a location between the light receiving hole 543 and the location of the light source 520. However, it should be understood that the light intercepting rib 545 may be variously designed without being limited to the above-mentioned structure if the light intercepting rib 545 can effectively intercept the light radiated from the light source 520 inside and outside the darkroom structure 540.

Further, it is preferred that bosses 547 protrude on the upper surface of the darkroom structure 540 at locations opposite to the light intercepting rib 545 based on the light receiving hole 543 such that the bosses 547 can be combined with the composite lens and prism structure 550.

The composite lens and prism structure 550 includes a condensing prism 551, which condenses the light radiated from the light source 520 onto the objective plane 571, and an imaging lens 553, which throws the light, reflected by the material that is in contact with the objective plane 571, on the light receiving sensor 530.

The composite lens and prism structure 550 is preferably configured such that the condensing prism 551 and the imaging lens 553 are integrated with a single plate structure into a single structure. Formed at a location between the condensing prism 551 and the imaging lens 553 is a rib locking hole 555, into which the light intercepting rib 545 of the darkroom structure 540 is inserted and locked. Here, the light intercepting rib 545 functions to stably lock the darkroom structure 540 to the composite lens and prism structure 550 and, at the same time, functions to optically isolate the condensing prism 551 from the imaging lens 553.

Further, the composite lens and prism structure 550 is provided with holes 557, into which the respective bosses 547 of the darkroom structure 540 are inserted, and with a locking boss 559, which protrudes upwards and is combined with the aperture structure 560.

The internal of the aperture structure 560 has a structure that selectively intercepts light. The aperture structure 560 is capable of realizing an external shape of the optically open stacked type optical device and is configured to intercept the diffused light from the objective plane 571.

The aperture structure 560 is a plate structure having a predetermined thickness and is stacked along with the composite lens and prism structure 550 inside the cover structure 570. Here, the aperture structure 560 may be made of one of silicone, epoxy and synthetic resin or made of a mixture prepared by mixing at least two of these materials. Of course, the aperture structure 560 may be made of a variety of materials without being limited to the above-mentioned materials so long as the materials can intercept light and can realize the function as an aperture and can be stably assembled inside the cover structure 570.

Particularly, the aperture structure 560 has a first hole 561, which has an open structure capable of allowing the light passing through the condensing prism 551 of the composite lens and prism structure 550 to be received by the objective plane 571, and a second hole 563, which is formed at a location spaced apart from the first hole 561 and defines an aperture stop at the location above the imaging lens 553 of the composite lens and prism structure 550.

Here, the second hole 563 may be configured to have a circular structure, while the first hole 561 may be configured to have a general rectangular shape.

Described in detail, the composite lens and prism structure 554 is provided with a rectangular structure 560a in the form of a hole or a recess in the central portion thereof for defining both the second hole 563 and the first hole 561. The rectangular structure 560a is open in one side, thus defining the first hole 561, and is configured as a closed structure 560b in the other side, thus defining the second hole 563 in the center. Further, it is preferred that, in the closed structure 560b, a portion located around the first hole 561 be configured as an inclined structure 560c capable of allowing the light to be effectively thrown on the objective plane placed above the second hole 563 through the first hole 561.

Further, the aperture structure 560 is configured such that it can be assembled with the composite lens and prism structure 550. Therefore, in the aperture structure 560, a locking hole 569 is formed to be combined with the locking boss 559 of the composite lens and prism structure 550. Here, the numbers and locations of both the locking boss 559 and the locking hole 569 may be appropriately changed according to practice conditions.

Further, as shown in FIGS. 5 and 7, an inclined reflective surface 551a is formed in the back surface of the condensing prism 551 of the composite lens and prism structure 550. Further, the aperture structure 560 is provided with an inclined protrusion 560d, which inclinedly protrudes to stably support the inclined reflective surface 551a in a state in which the inclined protrusion 560d is in contact with the inclined reflective surface 551a.

The cover structure 570 has a cap structure capable of protecting the darkroom structure 540, the composite lens and prism structure 550 and the aperture structure 560 therein. The cover structure 570 has a lower flange 573, which is mounted on the PCB 510.

Particularly, the cover structure 570 is made of a semitransparent material in at least the upper surface thereof, thus allowing the light to pass therethrough and realizing a design of the external shape of the optically open stacked type optical device. The objective plane 571 defined in the upper surface of the cover structure 570 may be configured as a window made of a transparent acrylic material so that, when an external material comes into contact the objective plane 571, the objective plane 571 can reflect the light from the light source 520 to the light receiving sensor 530.

In the above-mentioned optically open stacked type subminiature optical device according to the embodiment of the present invention, the PCB 510, the darkroom structure 540, the composite lens and prism structure 550 and the aperture structure 560 are sequentially stacked from the lower end to form an assembly and, thereafter, the assembly is covered with the cover structure 570, thus producing an integrated optically open stacked type subminiature optical device.

Particularly, the bosses 547 of the darkroom structure 540 are inserted into the respective holes 557 of the composite lens and prism structure 550 and the locking boss 559 of the composite lens and prism structure 550 is inserted into the locking hole 569 of the aperture structure 560, so that the load imposed on the PCB 510 from the interior structures can be minimized, thus preventing damage to the PCB 510 and preventing a reduction in the assembly work efficiency and realizing a free design of the PCB. Further, the darkroom structure 540, the composite lens and prism structure 550 and the aperture structure 560 are assembled with each other into an integrated structure, so that it is possible to easily assemble the interior parts with each other into the integrated structure and to minimize the assembly error, such as movement of the parts, after assembling the parts, thereby realizing a stable assembly structure.

Further, FIG. 8 illustrates the incidence of ambient diffused light 520 from the outside into the interior of the cover structure 570 when constructing the cover structure 570 having the optically open stacked structure without using the above-mentioned aperture structure 560.

However, in the present invention, because the cover structure 570 having the optically open stacked structure is provided with the aperture structure 560 therein, it is possible to intercept the diffused light from the objective plane 571. Therefore, the present invention can realize the optical device designed in the form of the optically open stacked structure and having reliable optical performance.

The technical scope and spirit described in the above-mentioned embodiment of the present invention may be independently embodied or may be combined with each other prior to being embodied. Further, although the embodiment of the present invention has been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the optically open stacked type subminiature optical device according to the present invention can be used as a subminiature optical sensor module in a subminiature pointing device, an input device and a subminiature fingerprint verification device.

In other words, the optically open stacked type subminiature optical device according to the present invention can be embedded in a variety of mobile digital instruments, such as a notebook computer or an UMPC, in addition to a mobile communication terminal and can realize a highly efficient pointing function inside a limited space, so that the optical device can be effectively used with wire or wireless keyboards, in which subminiature highly efficient pointing devices must be embedded or attached. Further, the present invention can realize a subminiature thin pointing function, thus being effectively used as an optical device, which can substitute for conventional input devices of mobile communication terminals or can add pointing functions to the mobile communication terminals. Further, the optical device of the present invention can be used as a subminiature pointing device in a mobile game machine. Further, the optical device of the present invention can be used in a remote control system for the home-network environment, thus realizing a multi-functional highly efficient remote control system.

1. An optically open stacked type subminiature optical device, comprising:
a light source and a light receiving sensor mounted on a PCB;
a darkroom structure installed on the PCB in such a way that the darkroom structure can cover the light receiving sensor and light thrown on the light receiving sensor can pass through the darkroom structure;
a composite lens and prism structure, which is stacked on an upper end of the darkroom structure and condenses light from the light source to an objective plane, and condenses the light reflected by the objective plane to the light receiving sensor;
a cover structure made of a semitransparent material and forming the objective plane in an uppermost end of the optical device, the cover structure being mounted to the PCB in such a way that the cover structure can cover both the composite lens and prism structure and the darkroom structure; and
an aperture structure having a plate shape and mounted on an upper end of the composite lens and prism structure inside the cover structure, the aperture structure intercepting diffused light from the objective plane of the cover structure and having open holes for allowing both light passing through the composite lens and prism structure and being thrown on the objective plane and light reflected by the objective plane to pass therethrough.

2. The optically open stacked type subminiature optical device as set forth in claim 1, wherein the darkroom structure, the composite lens and prism structure and the cover structure are stacked and assembled with each other, in which a boss protrudes from one of facing structures and a hole is formed in another structure of the facing structures so as to be combined with the boss.
